(19) United States
(12) Patent Application Publication
(10) Pub. No.: US 2007/0016863 A1
(43) Pub. Date: Jan. 18, 2007

(54) Method and apparatus for extracting and structuring domain terms

(76) Inventors: Yan Qu, Pittsburgh, PA (US); Nasreen Abduljaleel, Seattle, WA (US)

Correspondence Address: JONES DAY, 500 GRANT STREET, SUITE 3100, PITTSBURGH, PA, 15219-2502, US

(21) Appl. No.: 11/482,344

(22) Filed: Jul. 7, 2006

Related U.S. Application Data
(60) Provisional application No. 60/697,371, filed on Jul. 8, 2005.

(51) Int. Cl. G06F 17/00

(52) U.S. Cl. 715/702

(57) ABSTRACT

A method of automatically categorizing terms extracted from a text corpus is comprised of identifying lexical atoms in a text corpus as terms. The identified terms are extracted based on a relation that exists between the terms. A weight is assigned to each relation. A graphical representation of the relationships among terms is constructed by using terms as vertices and relations as weighted links between the vertices. A vertex score is calculated for each of the vertices of the graph. Each term is categorized based on its vertex score. The graphical representation may be revised based on its structure and/or the calculated vertex scores. Because of the rules governing abstracts, this abstract should not be used to construe the claims.

This application claims priority from U.S. Patent application Ser. No. 60/697,371 filed Jul. 8, 2005 and entitled Domain Term Extraction and Structuring via Link Analysis, the entirety of which is hereby incorporated by reference.

### BACKGROUND

This invention relates to the mining of structures from unstructured natural language text. More particularly, this invention relates to methods and an apparatus for extracting and structuring terms from text corpora.

In many disciplines involving conceptual representations, including artificial intelligence, knowledge representation, and linguistics, it is generally assumed that concepts, the associated attributes of concepts, and the relationships between concepts are an important aspect of conceptual representation. For the purpose of the current invention, a concept may refer to a physical or abstract entity. Each concept may have associated properties, describing various features and attributes of the concept. A concept may be related to one or more other concepts.

To create a good conceptual representation for a particular domain, hereinafter referred as a domain model, it is necessary to identify the important keywords or domain terms that describe a domain. Such a list of domain terms provides an unstructured summary of the main aspects of the domain. For example, for a wine-drinking domain, important terms may include “wine”, “grape”, “winery”, “color”, “body”, and “flavor”; subtypes of “wine” such as “white wine”, “red wine”; specific instances of wine, such as “Château Lafite Rothschild Pauillac” wine; and values of properties or instances, such as “full” for body.

The domain terms can be further structured as concepts, e.g., “wine”, “red wine”, “white wine”; associated properties, e.g., “color”, “body, “flavor”; and property values, e.g., “full” body, “low” tannin level.

For the current disclosure, a domain model can be extended to include individual instances of domain concepts. For example, the instance “Château Lafite Rothschild Pauillac” wine has a “full” body and is produced by the “Château Lafite Rothschild winery.” In this instance, the “body” property has been instantiated with the value “full” and the “maker” property has been instantiated with the value “Château Lafite Rothschild winery.”

Known methods for domain modeling generally divide the problem into two stages: first, extracting domain terms, and second, structuring the terms. Term extraction methods aim to extract from a corpus the important terms that describe the main topics of the corpus and rank these terms based on certain corpus statistics, such as frequency, inverse document frequency, or a combination of these or other measures. See a description of such methods in Milic-Frayling, N., et al., “CLARIT Compound Queries and Constraint-Controlled Feedback in TREC-5 Ad-Hoc Experiments”, 1996, in The Fifth Text REtrieval Conference (TREC-5), Gaithersburg, Md., USA, Nov. 20-22, 1996. National Institute of Standards and Technology (NIST), Special Publication 500-238.

In another known method for term extraction, linguistic units are linked to form graphs, and graph-based algorithms such as PageRank (see Brin, S. & Page, L., 1998, “The anatomy of a large-scale hypertextual Web search engine”, Computer Networks and IDSN Systems, 30(1-7)) or HITS (see Kleinberg, J. M., 1999, Authoritative sources in a hyperlinked environment”, Journal of the ACM, 46:604-632) are used for computing the importance scores of the vertices in the graphs as a way to select the most important terms. See a description of such methods in Mihalcea, R & Tarau, P, 2004, “TextRank: Bringing Order into Texts”, in Proceedings of the 42^{nd} Annual Meeting of the Association for Computational Linguistics, companion volume.

Methods on structuring terms include extraction and classification of certain pre-defined semantic relations, such as type_of relation and part_of relation. Such classification and extraction generally rely on using features or patterns either manually constructed or (semi-) automatically constructed based on training data annotated for the relations of interest. The requirement of pre-determination of the relation types and the specificity of the features and patterns used in these methods prevent such approaches from being useful in classifying broadly the relations of many term pairs.

In the case of automatically learning features or patterns, while the learning methods can be generalized to various semantic relations, they require hand-labeled data, which may be unavailable in many practical cases or too expensive or labor intensive to obtain. See a description of such a method in Turney, P. & Litmann, M., 2003, “Learning Analogies and Semantic Relations”, NRC/ERB-1103, NRC Publication Number: NRC: 46488.

Thus, a need exists for automatically extracting domain terms from a corpus and organizing the extracted terms in a structured relationship.

### SUMMARY

The present disclosure is directed to a method of automatically categorizing terms extracted from a text corpus. The method is comprised of identifying lexical atoms in a text corpus as terms. The identified terms are extracted based on a relation that exists between the terms. A weight is assigned to each relation. A graphical representation of the relationships among terms is constructed by using terms as vertices and relations as weighted links between the vertices. A vertex score is calculated for each of the vertices of the graph. Each term is categorized based on its vertex score. The graphical representation may be revised based on the calculated scores.

Another embodiment of the disclosure is directed to a method of automatically categorizing terms extracted from a text corpus as discussed above. In this embodiment, however, the graphical representation is revised based on the calculated vertex scores and a structure of the graph.

Another embodiment of the present disclosure is directed to a method of automatically categorizing terms extracted from a text corpus. The method is comprised of identifying lexical atoms in a text corpus as terms. Term pairs are extracted, with the term pairs having a weighted relation. A graphical representation of the relationships among terms is constructed by using terms as vertices and relations as weighted links between the vertices. A vertex score is calculated for each of the vertices of the graph. The vertices are categorized and the graph is reduced based on the structure of the graph. The vertices are further categorized based on the calculated vertex scores. The graphical representation may be revised based on the categorizing steps.

An apparatus, e.g., an appropriately programmed computer, for carrying out the methods of the present disclosure is also disclosed.

### BRIEF DESCRIPTION OF DRAWINGS

For the present disclosure to be easily understood and readily practiced, the present disclosure will be described, for purposes of illustration and not limitation, in conjunction with the following figures wherein:

FIG. 1 is a high-level block diagram of a computer system on which embodiments of the present disclosure may be implemented.

FIG. 2 is a process-flow diagram of an embodiment of the present disclosure.

FIG. 3 is an illustration of a dependency-based parsing of an English sentence.

FIG. 4 is an illustration of the construction of a graph using terms as vertices and relations as edges (links).

FIG. 5 is another illustration of a graph of terms linked by relations.

FIG. 6 is an illustration of an example of the process of categorizing the vertices into appropriate categories in the domain model and reducing the graph based on the structure of the graph.

FIG. 7 is a graph illustrating the relationship between terms in the digital camera domain.

FIG. 8 is an illustration of the graph of FIG. 7 after being reduced.

FIG. 9 is an illustration of the process of categorizing the vertices in a reduced graph into appropriate categories in the domain model based on the scores of the vertices.

### DESCRIPTION OF THE PREFERRED EMBODIMENTS

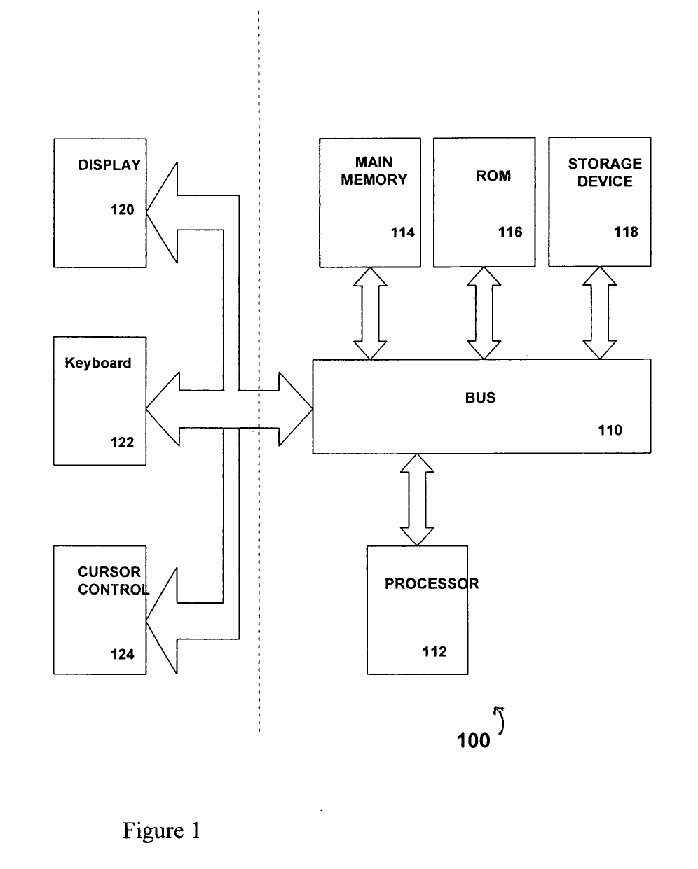

Referring to FIG. 1, there is shown a high-level block diagram of a computer system 100 on which embodiments of the present disclosure can be implemented. Computer system 100 includes a bus 110 or other communication mechanism for communicating information and a processor 112, which is coupled to the bus 110, for processing information. Computer system 100 further comprises a main memory 114, such as a random access memory (RAM) and/or another dynamic storage device, for storing information and instructions to be executed by the processor 112. For example, the main memory is capable of storing a program, which is a sequence of computer readable instructions, for performing the method of the present disclosure. The main memory 114 may also be used for storing temporary variables or other intermediate information during execution of instructions by the processor 112.

Computer system 100 also comprises a read only memory (ROM) 116 and/or another static storage device. The ROM is coupled to the bus 110 for storing static information and instructions for the processor 112. A data storage device 118, such as a magnetic disk or optical disk and its corresponding disk drive, can also be coupled to the bus 110 for storing both dynamic and static information and instructions.

Input and output devices can also be coupled to the computer system 100 via the bus 110. For example, the computer system 100 uses a display unit 120, such as a cathode ray tube (CRT), for displaying information to a computer user. The computer system 100 further uses a keyboard 122 and a cursor control 124, such as a mouse.

The present disclosure includes a method of identifying and structuring primary and secondary terms from text that can be performed via a computer program that operates on a computer system, such as the one illustrated in FIG. 1. According to one embodiment, term extraction and structuring is performed by the computer system 100 in response to the processor 112 executing sequences of instructions contained in the main memory 114. Such instructions may be read into the main memory 114 from another computer-readable medium, such as the data storage device 118. Execution of the sequences of instructions contained in the main memory 114 causes the processor 112 to perform the method steps that will be described hereafter. In alternative embodiments, hard-wired circuitry could replace or be used in combination with software instructions to implement the present disclosure. Thus, the present disclosure is not limited to any specific combination of hardware circuitry and software.

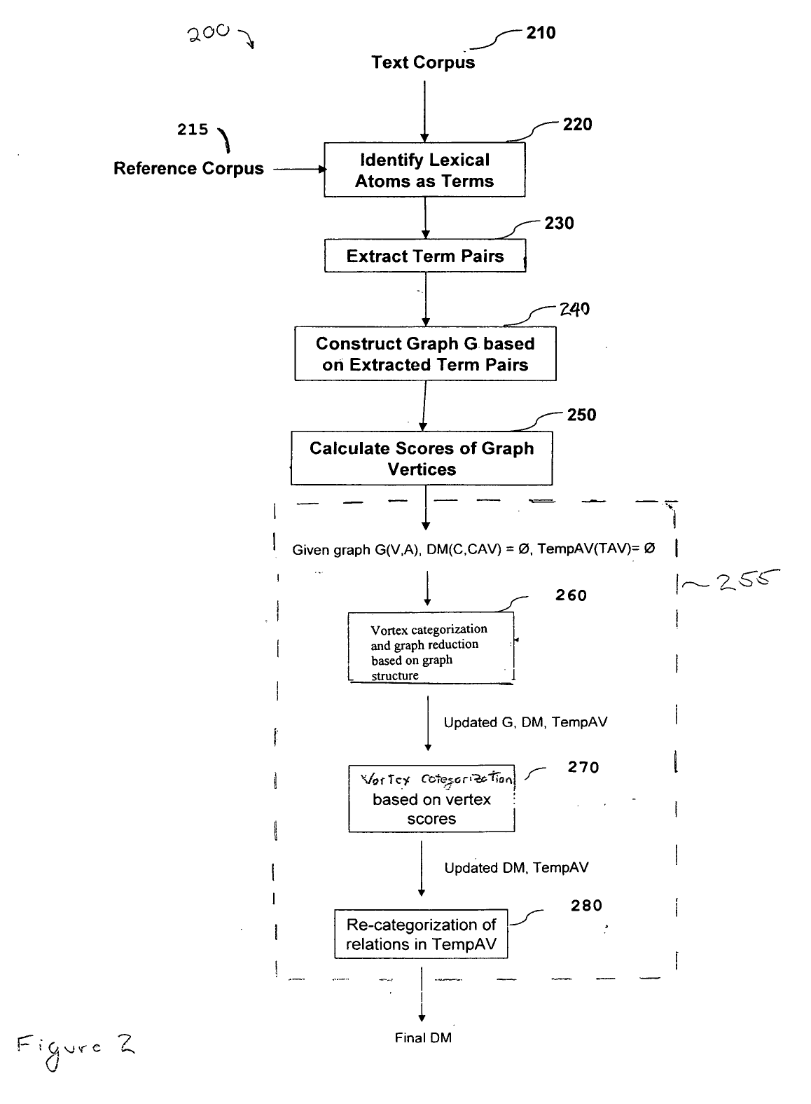

Referring to FIG. 2, there is shown a process-flow diagram for a method 200 of identifying and structuring terms, for example primary and secondary terms, from text. The method 200 can be implemented on the computer system 100 illustrated in FIG. 1. An embodiment of the method 200 of the present disclosure includes the step of the computer system 100 operating over a textual corpus 210. The selection of a corpus is normally a user input through the keyboard 122 or other similar device to the computer system 100. The corpus can be raw text without any pre-annotated structures or text with pre-annotated structures, such as linguistic annotations.

A pre-processing step 220 identifies the terms (or lexical units) used for text analysis. Terms can be as simple as tokens separated by spaces. Alternatively, terms can be lexical atoms, multi-word expressions or phrases that are treated as inseparable text units in later processing such as parsing. In step 220, lexical atoms are identified through a process that considers linguistic structure assignments to sequences of words and statistics relative to a reference corpus 215. Identification of sequences of words can be implemented by a variety of techniques known in the art such as the use of lexicons, morphological analyzers or natural language grammar structures. Alternatively, sequences can be constructed as word n-grams, removing selected subset of words such as articles and prepositions. In a preferred embodiment, sequences of words are identified by a significant statistical measure, such as mutual information MI(w1, w2), with an optional threshold for a cutoff.

The step 220 may be implemented, in one embodiment, by linguistic structures which are combined with corpus statistics as follows. Because many important domain terms are noun phrases, the first step is to compile a list of the compound noun phrases in a reference collection, such as 215. Then word bigrams (i.e., n=2) are extracted from these noun phrases observing the NP boundaries. The bigram “w₁w₂” consisting of words w₁ and w₂ is ranked by a statistic measure such as mutual information as follows:
Mutual information (w₁, w₂)=log[P(w₁ˆwt₂)/(P(w₁)*P(w₂))]
in which P(w₁ˆw₂) is the probability of observing bigram “w₁ w₂” in the corpus and is approximated as the number of times the bigram appears in the corpus divided by the total number of terms in the corpus. P(wᵢ) is the probability of observing wᵢ appearing in the corpus and is calculated as the number of times the word wᵢ occurs in the corpus over the number of total terms in the corpus. Word bigrams with mutual information scores above an empirically determined threshold value are kept as lexical atoms. The process iterates until lexical atoms up to length n are identified. The identified atoms are used as the units for building term pairs in step 230.

In step 230 in FIG. 2, pairs of terms are extracted based on certain relations that exist between them. A relation R between two terms t₁ and t₂ is represented as a tuple as follows:
<R, t₁, t₂, Wₜ₁ₜ₂>
in which R stands for a relation of interest between terms t₁ and t₂ and Wₜ₁ₜ₂ stands for the weight of the relation. As one embodiment, Wₜ₁ₜ₂ can be computed as the frequency count of observing terms t₁ and t₂ of relation R in text corpus 210. Alternatively, Wₜ₁ₜ₂ can be computed as the normalized frequency count over the total number of observed term-pair relations.

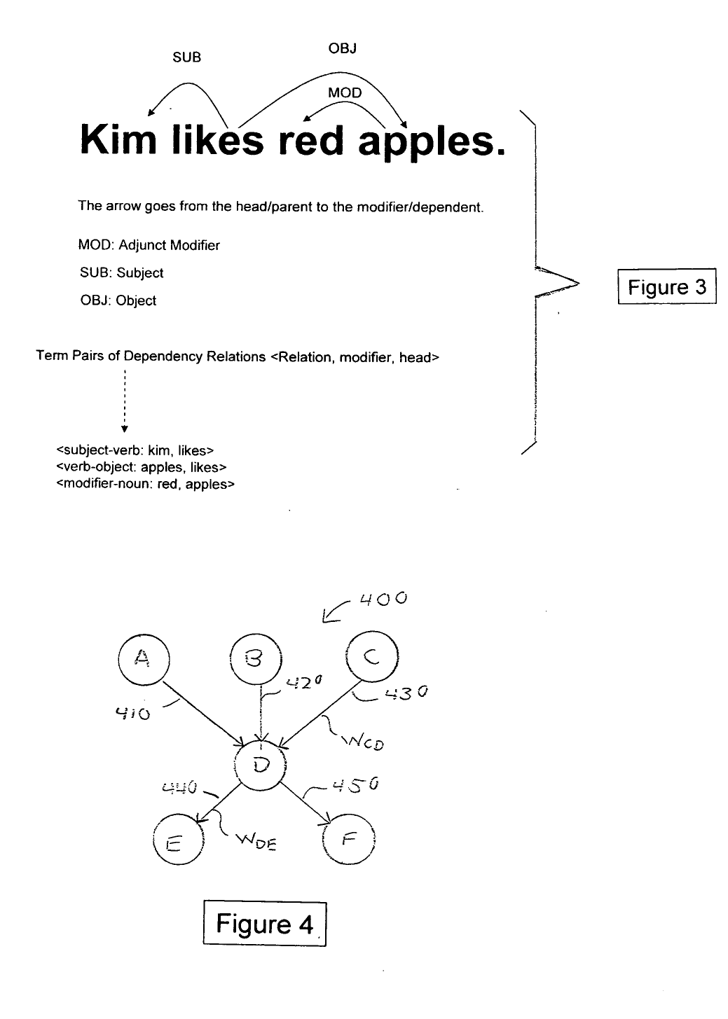

In a preferred embodiment, the relationship between terms is a dependency relationship, an asymmetric binary relationship between a term called head or parent, and another term called modifier or dependent. With a pre-determined set of grammatical functions such as subject, object, and modification, and a grammar, a variety of parsing techniques known in the art can be used to assign symbols in a sentence to their appropriate grammatical functions, which denote specific types of dependency relations. For example, in English, a modifier-noun relation is a dependency relation between a noun, which is the head of the relation, and a modifier, often as an adjective or noun that modifies the head. A subject-verb relation is a dependency relation between a verb, which is the head of the relation, and a subject, often as a noun serving as the subject of the verb. For example in the sentence “Kim likes red apples” in FIG. 3, “Kim” is identified as the subject with “likes” as the head, “apples” as the object with “likes” as the head, and “red” as a adjunct modifier with “apples” as the head.

Returning to step 230 in FIG. 2, using dependency-based parsers known in the art, grammatical functions between terms can be assigned to term pairs.

In another embodiment of the invention, term pairs can be extracted as two terms co-occurring in a pre-determined text window, with the window size ranging, e.g., from a certain number of tokens or bytes, to a sentence, a paragraph, or even a whole document, without considering the linguistic or grammatical relations. In such cases, the relation between the two terms is determined by the order of appearance in text, or a precedence relation.

In step 240, a graph is constructed based on the term pairs extracted from the text corpus 210, with the terms as vertices, and the relations between them as weighted links. The relation between terms determines the types of links existing between the corresponding vertices. As previously mentioned, relations can be term co-occurrence relations, dependency relations such as subject-head, head-object, modifier-noun relations, or other types of identifiable relations of interest. To reduce the length of the present disclosure, the remainder of the discussion of the method 200 will be limited to using the modifier-noun relation for constructing a term graph. Nevertheless, the scope of the present disclosure shall not be limited to the modifier-noun relation but shall include using other types of relations, such as subject-verb relations, verb-object relations, or co-occurring relations, among others, either individually or in combination with any or all of these relations.

The links between the vertices can be directed. The direction of the links can be determined empirically or based on linguistic judgment. For example, for a modifier-noun relation between a pair of vertices, the empirically preferred direction is from the modifier to the head noun, i.e., Modifier→Noun. The links from modifiers to head nouns are outbound links for the modifiers and inbound links for the head nouns.

Suppose, for example, that a relationship R exists between terms t1 and t2 with a weight of wₜ₁ₜ₂, and that relationship is denoted <R, t1, t2, wₜ₁ₜ₂>. Also suppose the following instances: <R, A, D, W_{AD}>, <R, B, D, W_{BD}>, <R, C, D, W_{CD}>, <R, D, E, W_{DE}>, and <R, D, F, W_{DF}>. An example of a graph 400 of those relationships is illustrated in FIG. 4. In FIG. 4, graph 400 is constructed as follows: terms correspond to vertices, relations correspond to links between vertices, and each link has a weight wₜ₁ₜ₂. The direction of the links between t1 and t2 of relation R can be either t1→t2 or t1←t2. The preferred direction can be empirically determined using task-oriented evaluation, among others. In FIG. 4, there are three inbound links 410, 420, 430 and two outbound links 440, 450 with respect to vertex D.

Each link 410, 420, 430, 440, 450 is associated with a weight that corresponds to, for example, the number of times (i.e., frequency) the corresponding relation occurs in the text corpus 210. Alternatively, the link weight can be normalized by dividing the frequency of the relation of the term pair with the total number of relations over all term pairs.

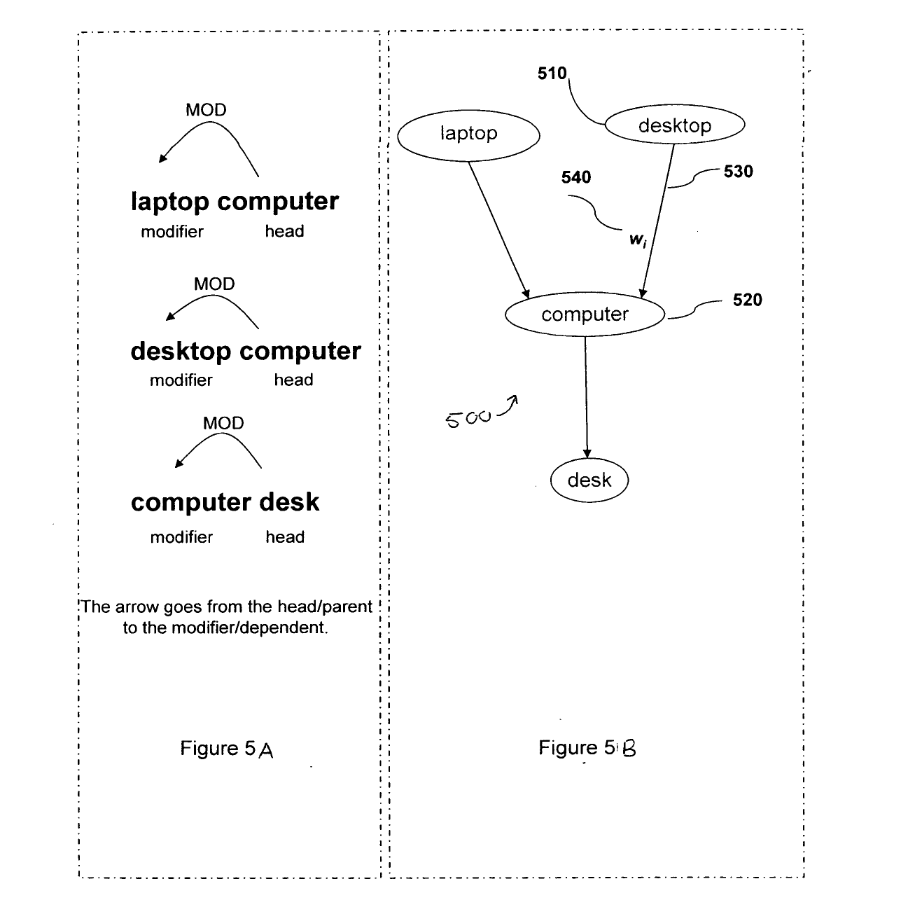

Turning now to FIG. 5, FIG. 5A illustrates relations and FIG. 5B illustrates a graph 500 constructed from the relations of FIG. 5A. The relation of interest is the modifier-noun relation existing between term pairs “laptop” and “computer”, “desktop” and “computer”, and “computer” and “desk” (FIG. 5A). In FIG. 5B, the modifiers and the head nouns are represented as vertices, with the links pointing from the modifiers to the head nouns. For example, the modifier “desktop” represented as vertex 510 is linked to the head noun “computer” represented as vertex 520 via a directed link 530, which is an outbound link in reference to vertex 510 and an inbound link in reference to vertex 520. Link 530 is associated with a weight 540.

Returning to FIG. 2, in step 250, graph-based ranking algorithms are used for deciding the importance (e.g. a vortex score) of a vertex in a graph based on information calculated recursively from the entire graph. Graph-based algorithms known in the art, such as PageRank and HITS, have been successfully applied to the ranking (scoring) of Web pages in the Internet domain.

In the Internet domain, a graph of page links is constructed based on the hyperlinks existing among Web pages. The HITS algorithm [Kleinberg 1999] gives each vertex in the graph a hub score and an authority score. In the context of the Web, a hub is a page that points to many important pages and an authority is a page that is pointed to by many important pages. The hub and authority scores of the vertices are calculated as follows:

$${HITS}_{H} ( {V}_{i} ) = {\sum }_{{V}_{j} ∈ Out ( {V}_{i} )} {HITS}_{A} ( {V}_{j} )$$

$${HITS}_{A} ( {V}_{i} ) = {\sum }_{{V}_{j} ∈ in ( {V}_{i} )} {HITS}_{H} ( {V}_{j} )$$

With respect to a graph of terms, the links between vertices are established by the linguistic relations as described earlier. A hub is defined as a term that points to many important terms; an authority is a term that is pointed to by many important terms. The hub and authority scores of the term vertices are calculated as follows:

$${HITS}_{H} ( {V}_{i} ) = {\sum }_{{V}_{j} ∈ Out ( {V}_{i} )} {w}_{ij} {HITS}_{A} ( {V}_{j} )$$

$${HITS}_{A} ( {V}_{i} ) = {\sum }_{{V}_{j} ∈ in ( {V}_{i} )} {w}_{ji} {HITS}_{H} ( {V}_{j} )$$

The formulae, when the edge (link) weights are set to 1, are the same as the HITS formulae and thus subsume the HITS formulae. A preferred embodiment is to set the weights so that they reflect the observed usage in the text corpus 210, such as raw frequencies or weighted frequencies.

At this step, vertices with scores below a certain threshold, considered unimportant, may be discarded from the graph. The threshold can be set based on the hub scores, the authority scores, or a combination of both hub and authority scores.

In another embodiment, the hub and authority scores of a vertex can be approximated based on the number of outbound links and the number of inbound links. A threshold for discarding unimportant vertices can be set based on the frequencies of the outbound links, the inbound links, or a combination of both types of links.

Returning to FIG. 2, in step 255, vertices in the graph of terms are categorized as either primary terms or secondary terms. Authority-like terms are considered primary terms or concepts. A concept is a key idea in a domain, which may be physical or abstract. The hub-like terms are considered secondary terms, or attributes and/or values (AV), of concepts. The categorization of the secondary terms in relation to the primary terms leads to the structuring of a domain model (DM(C,CAV)) where C is a set of concepts and CAV is a set of ordered, concept, AV pairs.

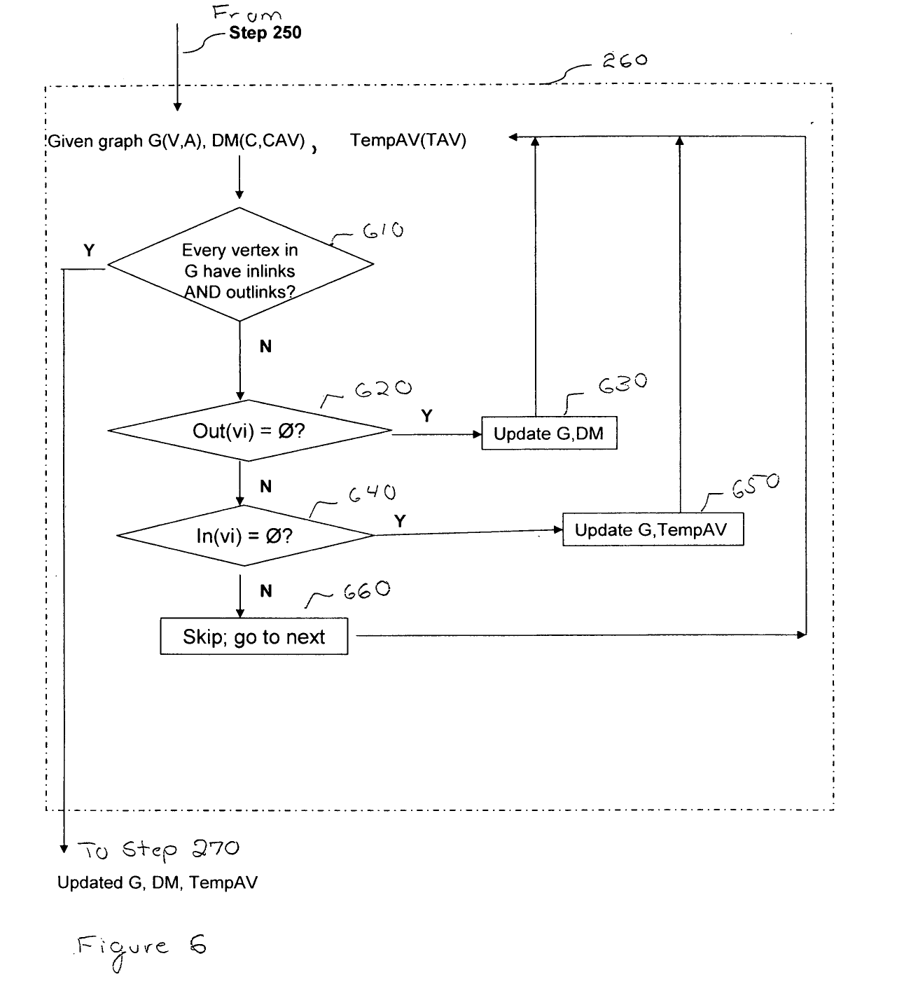

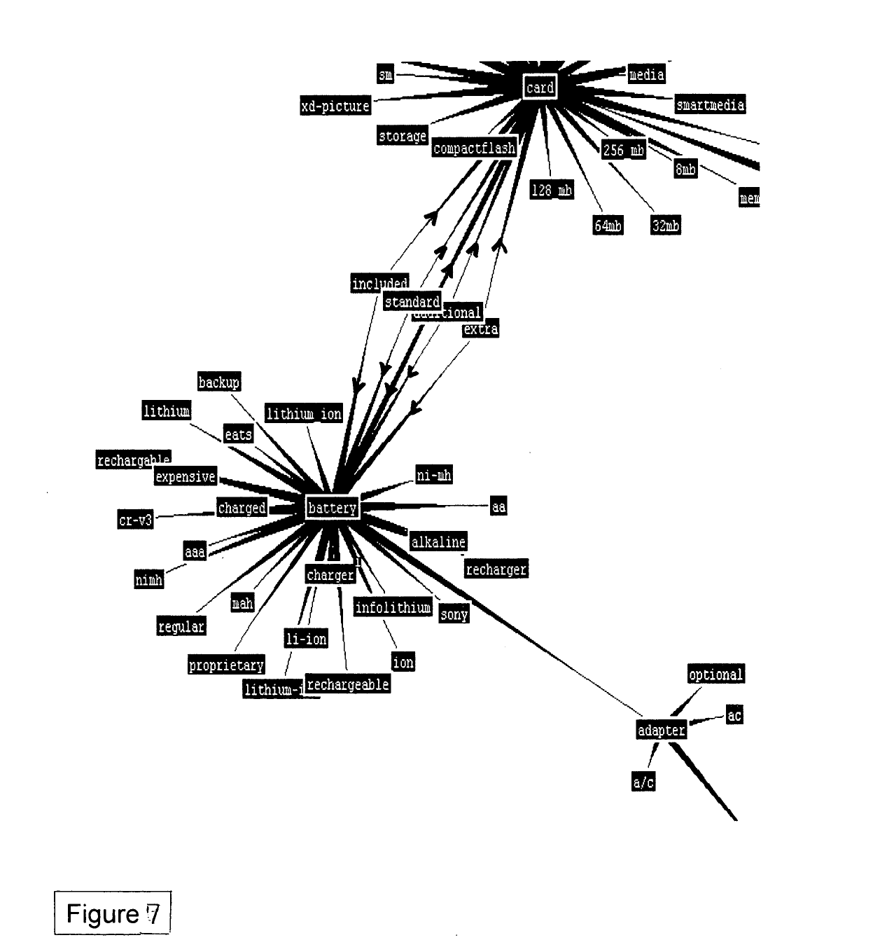

According to one embodiment, the step 255 may be comprised of several steps, beginning with step 260. In step 260, vertices are categorized based on the graph structure. A preferred embodiment of step 260 is illustrated in FIG. 6. In FIG. 6, the graph is checked at step 610 to determine whether every vertex has both inbound and outbound links. If yes, then the module exits and the process continues with step 270 in FIG. 2. If some vertices have empty inbound or outbound links, then the additional tests in FIG. 6 are performed. If at step 620 a vertex has no outbound links, then the term in that vertex is considered to be a concept. As shown in step 630, the term in that vertex is categorized in the domain model DM as a concept, and is removed from the graph G. Note that a graph (G(V,E)) is a graph consisting of V, a set of vertices or nodes, and E, a set of unordered pairs of distinct vertices called edges. A directed graph (G(V,A)) is a directed graph consisting of V, a set of vertices or nodes, and A, a set of ordered pairs of distinct vertices.

Next in FIG. 6, if a vertex v has outbound links but no inbound link as determined by step 640, then the term in that vertex is considered to be an AV of some concept(s) to be determined. If vertex v has an outbound link to u, then vertex v is considered a candidate AV of u and the pair <u, v> is added to a temporary store TempAV as shown by step 650, and vertex v is removed from the graph G. TempAV is a set of ordered <concept, av> pairs that are temporarily stored before adding them to the domain model DM. Lastly, if a vertex has both outbound links and inbound links as determined by steps 620 and 640, then that vertex remains in the graph and no updates are performed over DM, G, and TempAV as shown in step 660.

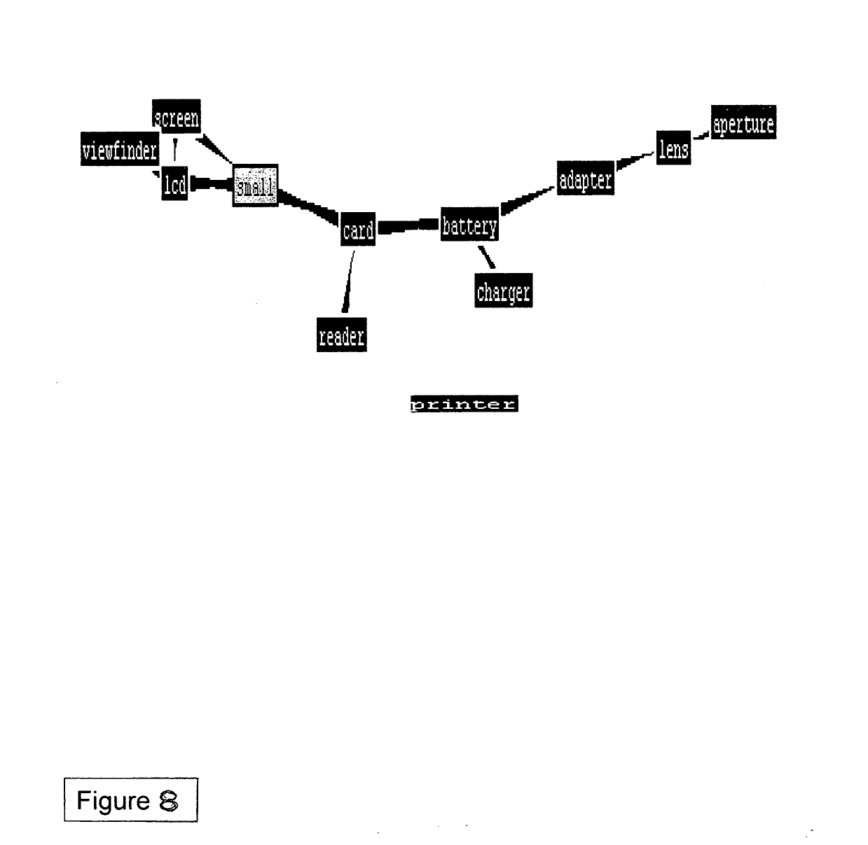

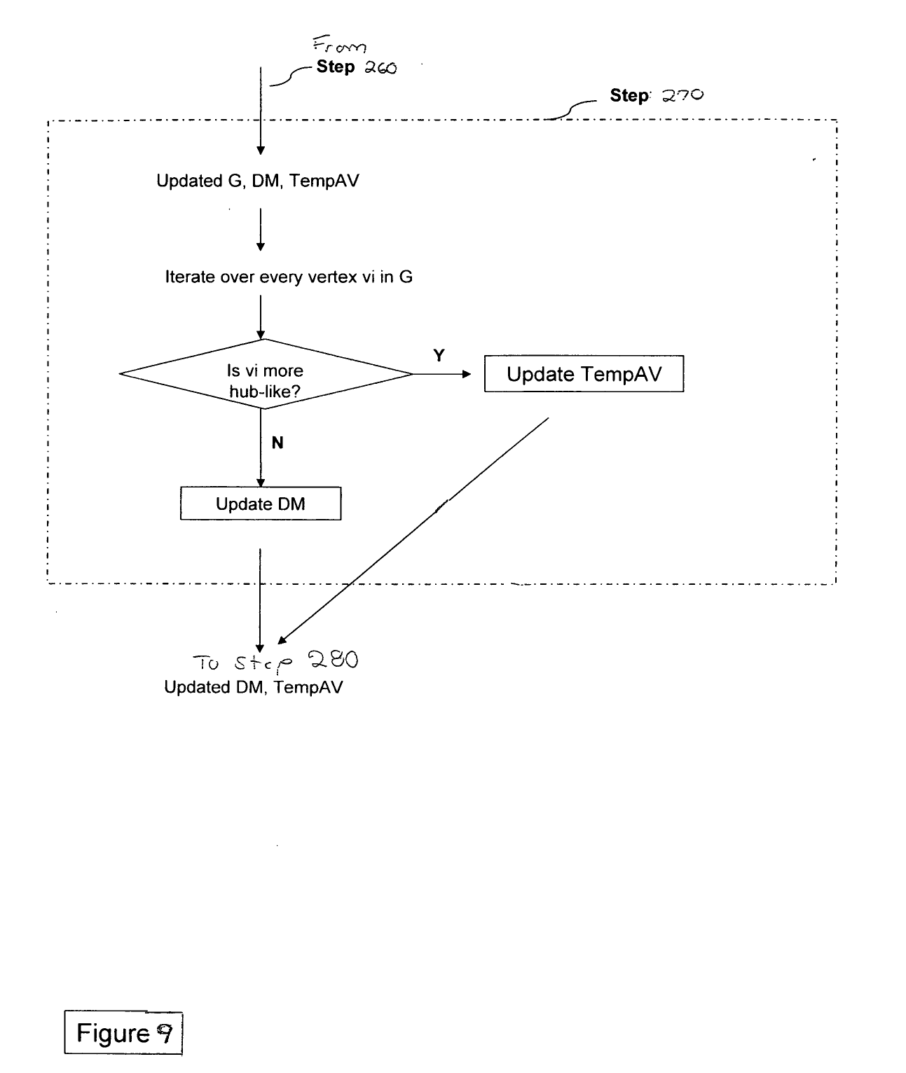

FIG. 7 illustrates an example of a graph in the digital camera domain. The vertex “backup” is a terminal vertex, which links into the vertex “battery”. The vertex “backup” is considered an AV for “battery”. The vertex “standard” has outbound links to both “battery” and “card”, so “standard” is an AV for “battery” and also an AV for “card”. The AV vertices are then removed from the graph, yielding a reduced graph in FIG. 8. The reduced graph could become a set of disconnected sub-graphs as a result of removing nodes and links. For example, the node “printer” becomes isolated in the reduced sub-graph in FIG. 8. In the next iteration, after step 660, the tests in FIG. 6 are performed again: isolated vertices such as “printer” are considered concepts at step 620.

Returning to FIG. 2, in step 270, as a result of step 260, all vertices in the reduced graph have inbound links and outbound links. Categorization of a vertex as a primary or secondary term is based on whether the vertex is more hub-like or authority-like as illustrated in FIG. 9. In FIG. 9, according to one embodiment, the computation of hub-like or authority-like character of a vertex v is based on the difference between the hub score and the authority score calculated in step 250 for each vertex v:
hub-ness(v)=hub_score(v)−authority_score(v)
If the difference is positive, which means the vertex demonstrates more “hub” characteristics, the term in the vertex is considered an AV of its linked vertices in Out(v). Otherwise, the term in the vertex is considered a concept. In the following example, “small” has a hub score 0.0408977157937711 and an authority score 0.00355678061129536. The difference between the hub score and the authority is positive (0.0373409351824757), which makes it an AV. In contrast, the difference of the hub score and the authority score of the vertex “card” is negative, which makes it a concept.

$$0.0477428773594192 aperture$$

$$hub = 0.0477532242159735$$

$$auth = 1.03468565542591 e - 05$$

$$0.0373409351824757 small$$

$$hub = 0.0408977157937711$$

$$auth = 0.00355678061129536 \\ - 1.03494518330773 e - 05 adapter$$

$$hub = 0$$

$$auth = 1.03494518330773 e - 05 \\ - 0.176238044153157 card$$

$$hub = 0.0167290992319075$$

$$auth = 0.192967143385065 \\ - 0.0858134930656465 battery$$

$$hub = 7.36195059039341 e - 19$$

$$auth = 0.0520921833700525 \\ - 0.0210289797097227 icd$$

$$hub = 0.00728712038596805$$

$$auth = 0.0283161000956908 \\ - 0.0108227304588608 charger$$

$$hub = 0$$

$$auth = 0.0108227304588608 \\ - 0.0103149588877932 screen$$

$$hub = 0.00120502930110471$$

$$auth = 0.0115199881888979 \\ - 0.00675797457800427 reader$$

$$hub = 0$$

$$auth = 0.00675797457800427 \\ - 0.00195017810469609 viewfinder$$

$$hub = 0$$

$$auth = 0.00195017810469609$$

In an alternative embodiment of the present invention, the hub or authority scores of a vertex can be computed simply as the numbers of outbound links or inbound links related to the vertex. To determine whether a vertex is more hub-like or more authority-like, the difference between the number of the outbound links and the number of the inbound links can be computed.

In yet another embodiment for determining whether a vertex is more hub-like or more authority-like, the ratio between the number of the outbound links and the inbound links can be used.

Returning to FIG. 2, in step 280, the concept-AV pairs that are temporarily stored in TempAV from step 270 are re-categorized and the domain model DM from step 270 is updated. For a term pair <u, v> in TempAV, in which v is considered AV of u, term u is checked against the current domain model DM. If u is a concept in DM, then the pair <u, v> is added to the ordered list CAV in DM. If u is an AV of a concept c in DM, then the pair <c, v> is added to DM, treating v as the AV of the concept c.

In the final domain model, concepts can be ranked by weights associated with the vertices. One statistic for ranking is their authority scores. Concepts can be ranked in decreasing order of their authority scores. Alternatively, concepts can be ranked in decreasing order of the number of the inbound links.

The association between concepts and AVs can also be ranked by the raw or normalized frequencies of the links between the vertices representing the concepts and AVs.

Although the invention has been described and illustrated with respect to the exemplary embodiments thereof, it should be understood by those skilled in the art that the foregoing and various other changes, omissions, and additions may be made without departing from the spirit and scope of the invention.

What is claimed is:

1. A method of automatically categorizing terms extracted from a text corpus, comprising:
extracting terms from a text corpus based on a relation that exists between terms;
assigning a weight to each relation;
constructing a graphical representation of the relations among terms by using terms as vertices and relations as weighted links between the vertices;
calculating a vertex score for each of said vertices of the graph; and
categorizing each term based on its vertex score.

2. The method of claim 1 wherein said extracting terms comprises extracting term pairs, and wherein said type of relation comprises one of a co-occurrence in a predetermined text window and a grammatical relation.

3. The method of claim 1 wherein said assigning a weight to each relation comprises assigning a weight based on a frequency of occurrence.

4. The method of claim 1 wherein said calculating a vertex score comprises calculating a score based on one of the number of times a vertex is mentioned and the number of links for the vertex.

5. The method of claim 1 wherein said calculating a vertex score comprises calculating scores for hub-like and authority-like characteristics, and wherein said categorizing comprises calculating the difference between said hub-like and said authority-like scores.

6. The method of claim 1 additionally comprising revising said graphical representation based on said categorizing.

7. The method of claim 6 wherein said revising comprises removing from the graphical representation vertices having a vertex score below a predetermined threshold

8. A method of automatically categorizing terms extracted from a text corpus, comprising;
identifying lexical atoms in a text corpus as terms;
extracting term pairs, said term pairs having a weighted relation;
constructing a graphical representation of the relationships among terms by using terms as vertices and relations as weighted links between the vertices; and
calculating a vertex score for each of said vertices of the graph;
categorizing each term based on its vertex score.

9. The method of claim 8 wherein said calculating a vertex score comprises calculating a score based on one of the number of times a vertex is mentioned and the number of links for the vertex.

10. The method of claim 8 wherein said calculating a vertex score comprises calculating scores for hub-like and authority-like characteristics, and wherein said categorizing comprises calculating the difference between said hub-like and said authority-like scores.

11. The method of claim 8 additionally comprising revising said graphical representation based on said categorizing.

12. The method of claim 11 wherein said revising comprises removing from the graphical representation vertices having a vertex score below a predetermined threshold.

13. The method of claim 8 additionally comprising revising said graphical representation based on a structure of the graph.

14. The method of claim 13 wherein said revising based on a structure of the graph comprises removing vertices having no outbound links.

15. The method of claim 13 wherein said revising based on a structure of said graph comprises recatagorizing vertices having outbound links but no inbound links.

16. A method of automatically categorizing terms extracted from a text corpus, comprising:
identifying lexical atoms in a text corpus as terms;
extracting term pairs, said term pairs having a weighted relation;
constructing a graphical representation of the relationships among terms by using terms as vertices and relations as weighted links between the vertices;
calculating a vertex score for each of said vertices of the graph;
categorizing vertices and reducing the graph based on a structure of the graph;
categorizing vertices based on the calculated vertex scores; and
revising the graphical representation based on said categorizing steps.

17. The method of claim 16 wherein said calculating a vertex score comprises calculating scores based on one of the number of times a vertex is mentioned and the number of links for the vertex.

18. The method of claim 16 wherein said calculating a vertex score comprises calculating scores for hub-like and authority-like characteristics, and wherein said categorizing vertices based on the calculated score comprises calculating the difference between said hub-like and said authority-like scores.

19. The method of claim 16 wherein said revising comprises removing from the graphical representation vertices having a vertex score below a predetermined threshold.

20. The method of claim 16 wherein said categorizing and reducing based on a structure of the graph comprises removing vertices having no outbound links.

21. The method of claim 16 wherein said categorizing and reducing based on a structure of the graph comprises recatagorizing vertices having outbound links but no inbound links.

22. A computer readable medium carrying a set of instructions which, when executed, perform a method comprising:
extracting terms from a text corpus based on a relation that exists between terms;
assigning a weight to each relation;
constructing a graphical representation of the relations among terms by using terms as vertices and relations as weighted links between the vertices;
calculating a vertex score for each of said vertices of the graph; and
categorizing each term based on its vertex score.

23. A computer readable medium carrying a set of instructions which, when executed, perform a method comprising:
identifying lexical atoms in a text corpus as terms;
extracting term pairs, said term pairs having a weighted relation;
constructing a graphical representation of the relationships among terms by using terms as vertices and relations as weighted links between the vertices; and
calculating a vertex score for each of said vertices of the graph;
categorizing each term based on its vertex score.

24. A computer readable medium carrying a set of instructions which, when executed, perform a method comprising:
identifying lexical atoms in a text corpus as terms;
extracting term pairs, said term pairs having a weighted relation;
constructing a graphical representation of the relationships among terms by using terms as vertices and relations as weighted links between the vertices;
calculating a vertex score for each of said vertices of the graph;
categorizing vertices and reducing the graph based on a structure of the graph;
categorizing vertices based on the calculated vertex scores; and
revising the graphical representation based on said categorizing steps.
